(19) United States
(12) Patent Application Publication
(10) Pub. No.: US 2026/0340927 A1
(43) Pub. Date: Oct. 29, 2026

(54) METHOD AND APPARATUS FOR MEASURING CARGO

(71) Applicants: Hyundai Motor Company, Seoul (KR); Kia Corporation, Seoul (KR)

(72) Inventors: Jae Seung Jun, Hwaseong (KR); Minkooc Wee, Hwaseong (KR); Se Do Oh, Hwaseong (KR); You Jin Shin, Hwaseong (KR)

(21) Appl. No.: 19/425,531

(22) Filed: Dec. 18, 2025

(30) Foreign Application Priority Data
Apr. 25, 2025 (KR) 10-2025-0054330

(51) Int. Cl. G06T 15/08; G01B 11/00; G06T 7/00

(52) U.S. Cl. CPC G06T 15/08; G01B 11/005; G06T 7/0004; G01B 2210/52; G06T 2207/10028

(57) ABSTRACT

A method for measuring cargo, comprising connecting to a multi-sensor-based cargo measuring device provided with 3D depth sensors, obtaining a plurality of raw point clouds corresponding to the cargo measured by the multi-sensor-based cargo measuring device, generating a single aligned point cloud by matching the plurality of raw point clouds to a single space, determining a corner point among points forming the aligned point cloud, determining a point other than the corner point among the points forming the aligned point cloud as a sampling-target point, performing down-sampling on the sampling-target point, generating a refined point cloud, by combining the point for which the down-sampling was performed and corner point, reconstructing a final model by inputting the refined point cloud into a deep learning model, and causing the deep learning model to predict a 3D mesh, and performing a measurement with respect to the cargo by using the final model.

### CROSS-REFERENCE TO RELATED APPLICATION

This application claims, under 35 U.S.C. §119(a), the benefit of Korean Patent Application No. 10-2025-0054330. filed Apr. 25, 2025, with the Korean Intellectual Property Office, the entire contents of which are incorporated herein by reference.

### BACKGROUND

### a. Technical Field

The present disclosure relates to a method and apparatus for measuring cargo and, more particularly, to a method and apparatus for measuring cargo and configured to measure large cargo accurately and quickly by generating a 3D mesh efficiently and with a high accuracy from a 3D point cloud of large cargo extracted from a large cargo measuring device.

### b. Background

In the modern logistics and air transportation industries, when large cargo is delivered to a cargo terminal, it is essential to accurately measure the weight, volume, length, height, and shape of the cargo. Such information plays an important role in calculating the cost of transporting the cargo and determining the loading sequence and position on the aircraft. However, there are several difficulties in accurately calculating the volume of large cargo.

Currently, workers use internal guidelines to stack, group, and package box-type loads. For regular cargo, the volume may be measured manually by using a tape measure, but the measurement results may vary depending on the skill of the worker. For irregular objects, volume measurement is more difficult. This type of manual method causes errors in calculating freight rates and is particularly problematic for calculating freight rates for irregular cargo, as accurate volume measurement is difficult. Existing measuring devices calculate box volume by considering the outermost part of large cargo as a rectangular parallelepiped, which has the problem of high error rate in volume measurement for irregular cargo or skid-mounted cargo, resulting in overcharges.

In addition, there may be a deviation in time and packaging results as workers manually package cargo according to internal guidelines. This deviation requires repackaging during aircraft loading, which reduces overall work efficiency. In particular, it may be difficult to determine the loading sequence due to the irregular shapes of the cargo and the unique structure with a rounded roof of the cargo space, which results in suboptimal loading, creating empty spaces and leading to cost losses.

The above information disclosed in this Background section is only for enhancement of understanding of the background of the present disclosure, and therefore it may contain information that does not form the related art that is already known to one having ordinary skill in the art.

### SUMMARY

The present disclosure attempts to provide a method and apparatus for measuring cargo capable of measuring large cargo accurately and quickly by generating a 3D mesh efficiently and with a high accuracy from a 3D point cloud of large cargo extracted from a large cargo measuring device.

A method for measuring cargo, performed by a computing device including a processor and a memory, may include connecting, by the processor, to a multi-sensor-based cargo measuring device provided with a plurality of 3D depth sensors, obtaining, by the processor, a plurality of raw point clouds corresponding to the cargo measured by the multi-sensor-based cargo measuring device, generating, by the processor, a single aligned point cloud by matching the plurality of raw point clouds to a single space, determining, by the processor, a corner point among points forming the aligned point cloud, determining, by the processor, a point other than the corner point among the points forming the aligned point cloud as a sampling-target point, performing, by the processor, down-sampling on the sampling-target point, generating, by the processor, a refined point cloud, by combining the point for which the down-sampling was performed and corner point, reconstructing, by the processor, a final model by inputting the refined point cloud into a deep learning model, and causing the deep learning model to predict a 3D mesh, and performing, by the processor, a measurement with respect to the cargo by using the final model.

The determining the corner point may include determining, by the processor, the corner point among the points forming the aligned point cloud based on voxels.

The determining the corner point may include generating, by the processor, a plurality of voxel grids by performing voxelization on an entire region of the aligned point cloud, identifying, by the processor, of a portion where a shape change exceeds a predetermined threshold value by analyzing distribution of internal points, for each of the plurality of voxel grids, and determining, by the processor, a point corresponding to the portion where the shape change exceeds the predetermined threshold value, as the corner point.

The determining the corner point may include determining, by the processor, the corner point among the points forming the aligned point cloud by analyzing a shape change of the aligned point cloud.

The determining the corner point may include estimating, by the processor, a normal vector with respect to each point, with respect to an entire region of the aligned point cloud, determining, by the processor, a direction of a surface on which each point is located based on the normal vector, and determining, by the processor, the corner point based on a direction of the surface.

The determining the corner point may include estimating, by the processor, a normal vector with respect to each point, with respect to an entire region of the aligned point cloud, determining, by the processor, a curvature corresponding to each point based on the normal vector, and determining, by the processor, the corner point based on the curvature.

The determining the corner point may include determining, by the processor, normal vector differences between the points, with respect to an entire region of the aligned point cloud, and determining, by the processor, the corner point based on the normal vector differences between the points.

The reconstructing the final model may include constructing, by the processor, a K-dimensional tree (KD-Tree) space based on a mesh vertex of the 3D mesh, placing, by the processor, a colored point cloud in the KD-Tree space, and calculating, by the processor, adjacent points and distances between the adjacent points.

The reconstructing the final model may include performing, by the processor, color matching by collecting colors of points adjacent to the mesh vertex, and reconstructing, by the processor, a colored mesh into the final model.

The reconstructing the final model may include generating, by the processor, a heatmap mesh based on the distance between the adjacent points, and reconstructing, by the processor, the heatmap mesh into the final model.

An apparatus for measuring cargo may include one or more non-transitory computer-readable media including an instruction, and one or more processors configured to perform an operation by executing the instruction, where the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, determining a corner point among points forming the aligned point cloud, determining a point other than the corner point among the points forming the aligned point cloud as a sampling-target point, performing down-sampling on the sampling-target point, generating a refined point cloud, by combining the point for which the down-sampling was performed and corner point, reconstructing a final model by inputting the refined point cloud into a deep learning model, and causing the deep learning model to predict a 3D mesh, and performing a measurement with respect to the cargo by using the final model.

The determining the corner point may include determining the corner point among the points forming the aligned point cloud based on voxels.

The determining the corner point may include generating a plurality of voxel grids by performing voxelization on an entire region of the aligned point cloud, identifying a portion where a shape change exceeds a predetermined threshold value by analyzing distribution of internal points, for each of the plurality of voxel grids, and determining a point corresponding to the portion where the shape change exceeds the predetermined threshold value, as the corner point.

The determining the corner point may include determining the corner point among the points forming the aligned point cloud by analyzing a shape change of the aligned point cloud.

The determining the corner point may include estimating a normal vector with respect to each point, with respect to an entire region of the aligned point cloud, determining a direction of a surface on which each point is located based on the normal vector, and determining the corner point based on a direction of the surface.

The determining the corner point may include estimating a normal vector with respect to each point, with respect to an entire region of the aligned point cloud, determining a curvature corresponding to each point based on the normal vector, and determining the corner point based on the curvature.

The determining the corner point may include determining normal vector differences between the points, with respect to an entire region of the aligned point cloud, and determining the corner point based on the normal vector differences between the points.

The reconstructing the final model may include constructing a K-dimensional tree (KD-Tree) space based on a mesh vertex of the 3D mesh, placing a colored point cloud in the KD-Tree space, and calculating adjacent points and distances between the adjacent points.

The reconstructing the final model may include performing color matching by collecting colors of points adjacent to the mesh vertex, and reconstructing a colored mesh into the final model, or generating a heatmap mesh based on the distance between the adjacent points, and reconstructing the heatmap mesh into the final model.

One or more non-transitory computer-readable media may include an instruction executable by a computing device, where the instruction causes the computing device to perform an operation when executed by one or more processors of the computing device, and the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, determining a corner point among points forming the aligned point cloud, determining a point other than the corner point among the points forming the aligned point cloud as a sampling-target point, performing down-sampling on the sampling-target point, generating a refined point cloud, by combining the point for which the down-sampling was performed and corner point, reconstructing a final model by inputting the refined point cloud into a deep learning model, and causing the deep learning model to predict a 3D mesh, and performing a measurement with respect to the cargo by using the final model.

According to an aspect of the present disclosure, a method for measuring cargo is provided. The method may comprise, using a computing device comprising a processor and a memory, obtaining a plurality of raw point clouds corresponding to cargo measured by a multi-sensor-based cargo measuring device provided with a plurality of 3D depth sensors, generating a single aligned point cloud by matching the plurality of raw point clouds to a single space, determining a corner point among points forming the aligned point cloud, determining a point other than the corner point among the points forming the aligned point cloud as a sampling-target point, performing down-sampling on the sampling-target point, generating a refined point cloud by combining the point for which the down-sampling was performed and corner point, reconstructing a final model by inputting the refined point cloud into a deep learning model, and causing the deep learning model to predict a 3D mesh, and performing a measurement with respect to the cargo by using the final model.

According to an exemplary embodiment, the determining the corner point may comprise determining the corner point among the points forming the aligned point cloud based on voxels.

According to an exemplary embodiment, the determining the corner point may comprise generating a plurality of voxel grids by performing voxelization on an entire region of the aligned point cloud, identifying a portion where a shape change exceeds a predetermined threshold value by analyzing distribution of internal points, for each of the plurality of voxel grids, and determining a point corresponding to the portion where the shape change exceeds the predetermined threshold value, as the corner point.

According to an exemplary embodiment, the determining the corner point may comprise determining the corner point among the points forming the aligned point cloud by analyzing a shape change of the aligned point cloud.

According to an exemplary embodiment, the determining the corner point may comprise estimating a normal vector with respect to each point, with respect to an entire region of the aligned point cloud, determining a direction of a surface on which each point is located based on the normal vector, and determining the corner point based on a direction of the surface.

According to an exemplary embodiment, the determining the corner point may comprise estimating a normal vector with respect to each point, with respect to an entire region of the aligned point cloud, determining a curvature corresponding to each point based on the normal vector, and determining the corner point based on the curvature.

According to an exemplary embodiment, the determining the corner point may comprise determining normal vector differences between the points, with respect to an entire region of the aligned point cloud, and determining the corner point based on the normal vector differences between the points.

According to an exemplary embodiment, the reconstructing the final model may comprise constructing a K-dimensional tree (KD-Tree) space based on a mesh vertex of the 3D mesh, placing a colored point cloud in the KD-Tree space, and calculating adjacent points and distances between the adjacent points.

According to an exemplary embodiment, the reconstructing the final model may comprise performing color matching by collecting colors of points adjacent to the mesh vertex, and reconstructing a colored mesh into the final model.

According to an exemplary embodiment, the reconstructing the final model may comprise generating a heatmap mesh based on the distance between the adjacent points, and reconstructing the heatmap mesh into the final model.

According to an aspect of the present disclosure, an apparatus for measuring cargo is provided. The apparatus may comprise a computing device, comprising a processor and a memory. The computing device may be configured to obtain a plurality of raw point clouds corresponding to cargo measured by a multi-sensor-based cargo measuring device provided with a plurality of 3D depth sensors, generate a single aligned point cloud by matching the plurality of raw point clouds to a single space, determine a corner point among points forming the aligned point cloud, determine a point other than the corner point among the points forming the aligned point cloud as a sampling-target point, perform down-sampling on the sampling-target point, generate a refined point cloud, by combining the point for which the down-sampling was performed and corner point, reconstruct a final model by inputting the refined point cloud into a deep learning model, and causing the deep learning model to predict a 3D mesh, and perform a measurement with respect to the cargo by using the final model.

According to an exemplary embodiment, the determining the corner point may comprise determining the corner point among the points forming the aligned point cloud based on voxels.

According to an exemplary embodiment, the determining the corner point may comprise generating a plurality of voxel grids by performing voxelization on an entire region of the aligned point cloud, identifying a portion where a shape change exceeds a predetermined threshold value by analyzing distribution of internal points, for each of the plurality of voxel grids, and determining a point corresponding to the portion where the shape change exceeds the predetermined threshold value, as the corner point.

According to an exemplary embodiment, the determining the corner point may comprise determining the corner point among the points forming the aligned point cloud by analyzing a shape change of the aligned point cloud.

According to an exemplary embodiment, the determining the corner point may comprise estimating a normal vector with respect to each point, with respect to an entire region of the aligned point cloud, determining a direction of a surface on which each point is located based on the normal vector, and determining the corner point based on a direction of the surface.

According to an exemplary embodiment, the determining the corner point may comprise estimating a normal vector with respect to each point, with respect to an entire region of the aligned point cloud, determining a curvature corresponding to each point based on the normal vector, and determining the corner point based on the curvature.

According to an exemplary embodiment, the determining the corner point may comprise determining normal vector differences between the points, with respect to an entire region of the aligned point cloud, and determining the corner point based on the normal vector differences between the points.

According to an exemplary embodiment, the reconstructing the final model may comprise constructing a K-dimensional tree (KD-Tree) space based on a mesh vertex of the 3D mesh, placing a colored point cloud in the KD-Tree space, and calculating adjacent points and distances between the adjacent points.

According to an exemplary embodiment, the reconstructing the final model may comprise performing color matching by collecting colors of points adjacent to the mesh vertex and reconstructing a colored mesh into the final model, or generating a heatmap mesh based on the distance between the adjacent points, and reconstructing the heatmap mesh into the final model.

According to an aspect of the present disclosure, a computing device is provided. The computing device may comprise a processor and a memory. The memory may be configured to store instructions that, when executed by the processor, are configured to cause the processor to obtain a plurality of raw point clouds corresponding to a cargo measured by a multi-sensor-based cargo measuring device provided with a plurality of 3D depth sensors, generate a single aligned point cloud by matching the plurality of raw point clouds to a single space, determine a corner point among points forming the aligned point cloud, determine a point other than the corner point among the points forming the aligned point cloud as a sampling-target point, perform down-sampling on the sampling-target point, generate a refined point cloud, by combining the point for which the down-sampling was performed and corner point, reconstruct a final model by inputting the refined point cloud into a deep learning model, and causing the deep learning model to predict a 3D mesh, and perform a measurement with respect to the cargo by using the final model.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a drawing for explaining an apparatus for measuring cargo, according to an exemplary embodiment of the present disclosure.

FIG. 2 illustrates a drawing for explaining a method for measuring cargo, according to an exemplary embodiment of the present disclosure.

FIGS. 3 and 4 illustrate drawings for explaining a method for measuring cargo, according to an exemplary embodiment of the present disclosure.

FIG. 5 illustrates a drawing for explaining a method for measuring cargo, according to an exemplary embodiment of the present disclosure.

FIGS. 6 and 7 illustrate drawings for explaining implementation examples of a method and apparatus for measuring cargo, according to an exemplary embodiment of the present disclosure.

FIG. 8 illustrates a drawing for explaining a computing device, according to an exemplary embodiment of the present disclosure.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Throughout the specification and claims, when a part "includes" a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

In addition, terms such as "... part," "... portion," " ... er/or," or "module" disclosed in the present specification may mean a unit that may process at least one function or operation described in this specification, and this may be implemented by hardware, software, or a combination thereof. Additionally, at least some of the configurations or functions of the method and apparatus for measuring cargo according to the embodiments described below may be implemented as a program or software, and the program or software may be stored in a computer-readable medium.

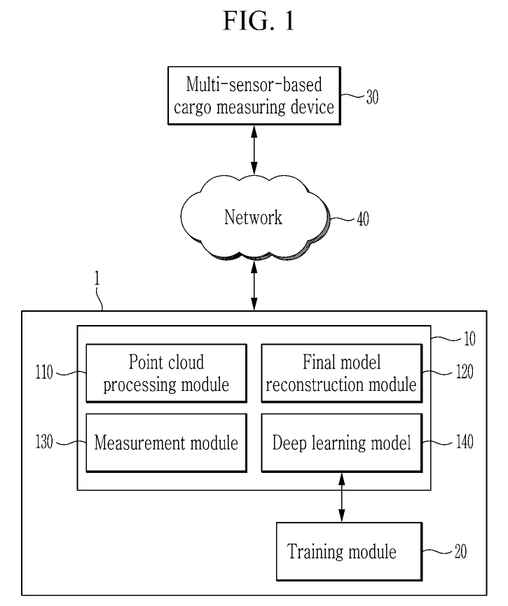

FIG. 1 illustrates a drawing for explaining an apparatus for measuring cargo, according to an exemplary embodiment.

Referring to FIG. 1, a system 1 for measuring cargo, according to an exemplary embodiment, may comprise an apparatus 10 configured to measure cargo, a training module 20, and a multi-sensor-based cargo measuring device 30. The apparatus 10 configured to measure cargo and the multi-sensor-based cargo measuring device 30 may be configured to exchange data with each other through a network 40, and the training module 20 may be configured to train a deep learning model 140 used in the apparatus 10 for measuring cargo by using a preset training data. In FIG. 1, the training module 20 is illustrated as an element implemented outside the apparatus 10 for measuring cargo, but depending on specific implementation purpose or environment, the training module 20 may be implemented inside the apparatus 10 for measuring cargo, or although not shown, may be implemented on a remote server. When implemented on a remote server, the apparatus 10 for measuring cargo may be provided with the deep learning model 140 for which training is completed, from a remote server through the network 40.

The multi-sensor-based cargo measuring device 30 may comprise and/or be provided with a plurality of 3D depth sensors. The plurality of3D depth sensors, each viewing the cargo from different angles, may be used to obtain a point cloud of the cargo. A plurality of raw point clouds may be obtained through the plurality of 3D depth sensors. On the other hand, the multi-sensor-based cargo measuring device 30 may further comprise a plurality of vision cameras. The plurality of vision cameras, each viewing the cargo from different angles, may be configured to be used to obtain an image of the cargo. A plurality of raw images may be obtained through the plurality of vision cameras. The multi-sensor-based cargo measuring device 30 may be configured to provide the plurality of raw point clouds and the plurality of raw images obtained in that way to the apparatus 10 for measuring cargo, through the network 40.

According to an exemplary embodiment, the number of 3D depth sensors and the number of vision cameras used in the multi-sensor-based cargo measuring device 30 may be set to be different from each other. According to an exemplary embodiment, the number of vision cameras may be set to greater than the number of 3D depth sensors. For example, in the multi-sensor-based cargo measuring device 30, six vision cameras may be used, while four 3D depth sensors may be used.

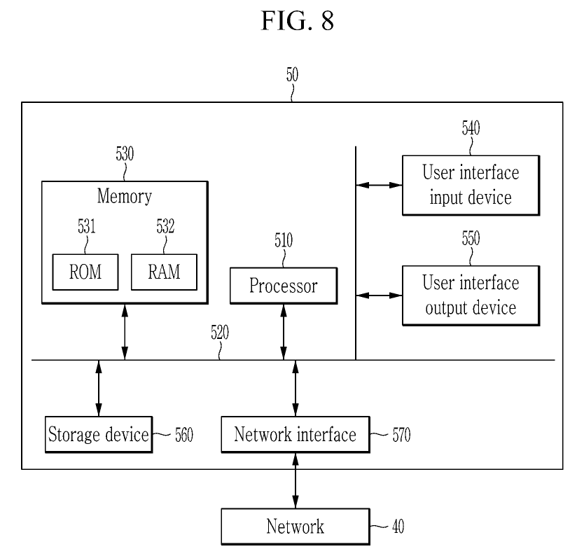

The apparatus 10 for measuring cargo, according to an exemplary embodiment, may comprise and/or be implemented as a computing device comprising a processor and a memory. For example, the apparatus 10 for measuring cargo may comprise and/or be implemented as a computing device 50, such as that described later with reference to FIG. 8. In this case, processor may correspond to a processor 510 of the computing device 50, and memory may correspond to a memory 520 of the computing device 50. Alternatively, according to an exemplary embodiment, the apparatus 10 for measuring cargo may comprise one or more non-transitory computer-readable media comprising an instruction and one or more processors configured to perform an operation by executing the instruction. Here, the operation may comprise the configuration, function, step, or the like explained in this specification with respect to a method and apparatus for measuring cargo according to embodiments. In this specification, the term “module” is used in order to logically differentiate these operations performed by a model compression method and apparatus according to embodiments.

The apparatus 10 for measuring cargo may comprise a point cloud processing module 110, a final model reconstruction module 120, a measurement module 130 and the deep learning model 140.

The point cloud processing module 110 may be connected to the multi-sensor-based cargo measuring device 30, and may be configured to obtain the plurality of raw point clouds corresponding to the cargo measured by the multi-sensor-based cargo measuring device 30. For example, if the multi-sensor-based cargo measuring device 30 uses four 3D depth sensors, the point cloud processing module 110 may be configured to obtain four raw point clouds corresponding to each.

The point cloud processing module 110 may be configured to generate a single aligned point cloud by matching the raw point cloud to a single space. This is known as point cloud registration, and may involve aligning the plurality of raw point clouds to a common coordinate system to generate a single, consistent data set. According to an exemplary embodiment, the point cloud processing module 110 may be configured to precisely align point clouds by first performing rough alignment by extracting feature points from the raw point cloud and finding corresponding points, and then repeatedly matching the nearest neighbors between points in each point cloud and minimizing the distance between the matched points. Additionally, a transformation matrix including rotation, translation, and scaling may be applied to each point cloud. When the plurality of raw point clouds are merged into a single common coordinate system, they may share the same reference frame, and during this process, the relative position and direction of each cloud may be adjusted.

The point cloud processing module 110 may be configured to perform preprocessing on the aligned point cloud, to generate a refined point cloud.

The point cloud processing module 110 may be configured to apply a plurality of point cloud samplings to the aligned point cloud. Here, the point cloud sampling may refer to selecting some points from a point cloud to adjust the density of data or improve processing efficiency.

The point cloud processing module 110 may be configured to determine a corner point among points forming the aligned point cloud. Here, the corner point may mean a point located at a boundary or corner area where a shape change of an object occurs rapidly among the points forming the aligned point cloud. Since these corner points contain feature information that represents the outer shape of the object and can clearly distinguish the shape, they may be points that are identified and preserved preferentially in order to perform efficient sampling while preserving the shape of the point cloud.

According to an exemplary embodiment, the point cloud processing module 110 may be configured to determine the corner point among the points forming the aligned point cloud based on voxels. Here, a voxel is a unit space that divides a three-dimensional space into grids of a certain size, and each voxel can represent the position and distribution information of points included within the space.

According to an exemplary embodiment, the point cloud processing module 110 may be configured to generate a plurality of voxel grids by performing voxelization with respect to the entire region of the aligned point cloud, may be configured to identify a portion where a shape change exceeds a predetermined threshold value by analyzing distribution of internal points, for each of the plurality of voxel grids, and may be configured to determine a point corresponding to the portion where the shape change exceeds the predetermined threshold as an edge point.

Voxelization is a process of dividing the entire three-dimensional space of the aligned point cloud into grid units with a regular interval, where each voxel has a fixed size according to a specified spatial resolution and can have position and density information of points included within that voxel. The point cloud processing module 110 may be configured to analyze point distribution within each voxel with respect to the plurality of voxel grids generated in this way, and may quantitatively calculate distribution characteristic based on, for example, spatial coordinates, directionality, density, or directionality of normal vectors of the points included in each voxel. Afterwards, if the difference between the distribution characteristics of points within a voxel changes rapidly beyond a certain threshold value, that position may be determined as a portion where the shape of the object changes rapidly, and the points included in the voxel where such shape change occurs can be classified as corner points.

According to an exemplary embodiment, a point cloud processing module 10 may be configured to determine the corner point among the points forming the aligned point cloud by analyzing the shape change of the aligned point cloud.

According to an exemplary embodiment, the point cloud processing module 110 may be configured to estimate a normal vector with respect to each point, with respect to the entire region of the aligned point cloud, may be configured to determine a direction of a surface on which each point is located based on the normal vector, and may be configured to determine the corner point based on the direction of the surface. Such a method based on the direction of the surface may determine the corner point by analyzing the directionality of a local surface to which each point belongs. For example, the point cloud processing module 110 may be configured to analyze whether a surface direction of each point has a specific directionality and clear boundary characteristics, and when the surface direction is non-uniformly distributed or a direction change occurs in the local region, that point may be determined as a point where the shape is rapidly changed and determined as the corner point.

According to an exemplary embodiment, the point cloud processing module 110 may be configured to estimate a normal vector with respect to each point, with respect to the entire region of the aligned point cloud, may be configured to determine a curvature corresponding to each point based on the normal vector, and may be configured to determine the corner point based on the curvature. Here, curvature is an indicator of the degree of curvature of the surface on which each point is located, and the point cloud processing module 110 may be configured to estimate the curvature value by analyzing the distribution of neighboring points located around each point. Specifically, for example, based on neighboring points within a certain radius centered on that point, the change in slope of a surface may be evaluated, and how sharply the surface is bent or curved may be determined. A larger curvature value indicates that the point is likely to be located in a region with abrupt shape changes, which would typically correspond to a corner or boundary of an object. Accordingly, the point cloud processing module 110 may be configured to select points having a curvature higher than a certain level, and determine them as corner points.

In some embodiments, the point cloud processing module 110 may be configured to determine normal vector differences between the points, with respect to the entire region of the aligned point cloud, and determine the corner point based on the normal vector differences between the points. The point cloud processing module 110 may be configured to evaluate the degree of change in surface slope by comparing the difference in direction between the normal vector of each point and the normal vectors of surrounding points. In general, the direction of the normal vector is similar between points located on the same plane or surface, but in regions where there is a sharp change in shape, such as corners or boundaries, the direction of the normal vector is significantly different. Accordingly, when the normal vector differences between the points exceeds the predetermined threshold value, that point may be considered to be located in a region where the shape changes abruptly and may be determined as a corner point.

The point cloud processing module 110 may be configured to determine a point other than the corner point among the points forming the aligned point cloud as a sampling-target point, and may perform down-sampling on the sampling-target point. In addition, the point cloud processing module 110 may be configured to generate the refined point cloud, by combining the point for which the down-sampling was performed and corner point.

That is, the point cloud processing module 110 may be configured to preferentially identify the corner points among all points that constitute the aligned point cloud, and determine the remaining points as sampling-target points. At this time, the corner points may be maintained in their raw state for accurate representation of the shape and boundary preservation, and the sampling-target points may be processed for the purpose of data simplification. Down-sampling may be performed on the sampling-target point, and accordingly, the number of the sampling-target points may be reduced as well as the overall shape or density characteristic of the ground-truth point cloud may be preserved as much as possible. Afterwards, the point cloud processing module 110 may be configured to generate the final refined point cloud by combining the down-sampled points and the previously preserved corner point.

On the other hand, the point cloud processing module 110 may be configured to additionally perform the following preprocessing.

According to an exemplary embodiment, the point cloud processing module 110 may be configured to separate the cargo and a bottom surface supporting the cargo from the aligned point cloud, and may precisely separate a boundary between the cargo and the bottom surface, with respect to a lower portion of the cargo that is not easily distinguished from the bottom surface. Subsequently, the point cloud processing module 110 may perform a task of removing the bottom surface from the aligned point cloud and leaving only the cargo.

In general, the point cloud data may comprise both cargo and the bottom surface, so a process of distinguishing the two elements may be required. In particularly, when the lower portion of the cargo is close to the bottom surface and the boundary is unclear, the point cloud processing module 110 may be configured to accurately identify the shape and position of the cargo by precisely separating the boundary between the cargo and the bottom surface. The point cloud processing module 110 may be configured to apply an algorithm that separates the cargo and the bottom surface, to perform the task of effectively detecting the bottom surface, and removing the bottom surface portion from the aligned point cloud, thereby leaving only the cargo. The above-described process may include a data refining step for volume measurement or shape analysis of the cargo, ultimately enabling accurate measurement and analysis. The bottom surface removal work may correspond to an important feature that reduces the complexity of point cloud data and allowing subsequent processing to focus solely on the cargo.

In some embodiments, the point cloud processing module 110 may be configured to set the threshold value based on a distance between the cargo and the bottom surface, and may perform precise separation, by additionally identifying a point corresponding to the bottom surface based on the threshold value. For example, the point cloud processing module 110 may be configured to analyze a position of each point, determine that a point within the threshold value range belongs to the bottom surface, and classify that point as the bottom surface. In this way, the points belonging to the bottom surface may be accurately identified even in the lower region of the cargo where the boundary with respect to the bottom surface is vague, enabling precise separation between the cargo and the bottom surface.

According to an exemplary embodiment, in order to divide the bottom surface, the point cloud processing module 110 may be configured to extract the bottom surface by a Random Sample Consensus (RANSAC) algorithm, and may be configured to divide the cargo based on the bottom surface. By adopting the RANSAC algorithm, a random point may be selected from the point cloud, to generate a plane model corresponding to the bottom surface, the points that fits well to the plane model may be identified as inliers to extract only the points constituting the bottom surface, and other points may be classified as the outliers and separated into cargo.

The final model reconstruction module 120 may be configured to reconstruct the final model, by inputting the refined point cloud into the deep learning model 140, and having the deep learning model 140 predict a 3D mesh. Specifically, the final model reconstruction module 120 may be configured to construct a K-dimensional tree (KD-Tree) space based on a mesh vertex of the 3D mesh. The mesh vertices have coordinates in three-dimensional space, and may be important elements that define the overall shape and structure of the mesh. The KD-Tree is a data structure for efficiently managing and searching the mesh vertices, and may partition the mesh vertices according to specific rules and store them in a tree form.

In addition, the final model reconstruction module 120 may be configured to place a colored point cloud in the KD-Tree space. The colored point cloud may have RGB color information for each point, and may provide data for coloring the 3D mesh. Each point of the colored point cloud may be mapped to the mesh vertex in the KD-Tree, and through this, may allow colors corresponding to each region of the mesh to be assigned.

In addition, the final model reconstruction module 120 may be configured to calculate adjacent points and distances between the adjacent points. The adjacent point may be efficiently searched by using the structure of the KD-Tree, and the color and uncertainty value of the mesh vertex may be estimated based on the calculated distance information. Through this process, the visual consistency of the mesh may be increased, and a final 3D model with color information may be completed.

According to an exemplary embodiment, the final model reconstruction module 120 may be configured to perform color matching by collecting colors of points adjacent to the mesh vertex, and may reconstruct a colored mesh into the final model.

According to an exemplary embodiment, the final model reconstruction module 120 may be configured to generate a heatmap mesh based on the distance between the adjacent points, and may be configured to reconstruct the heatmap mesh into the final model.

The measurement module 130 may be configured to perform measurement on the cargo by using the final model. The measurement module 130 may be configured to calculate, for example, a water volume with respect to the cargo. The water volume relates to a process of measuring an entire volume occupied by the cargo, and may mean the volume of water occupied by the cargo when the cargo is submerged in a certain water tank. The measurement module 130 may be configured to calculate the water volume by mathematically integrating the interior space of the cargo by using the 3D mesh model, or by estimating the volume based on outer lines and surfaces of the cargo. This function enables accurate volume measurement even when the size or shape of the cargo is irregular, and may provide useful data for calculating the cost of transporting cargo or for establishing loading plans.

According to an exemplary embodiment of the present embodiment, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In particular, unnecessary points may be removed from the 3D point cloud obtained from the multi-sensor-based cargo measuring device, and the 3D mesh may be efficiently generated by selecting and sampling only representative points. Accordingly, the amount of data of the point cloud can be reduced, and the shape and volume of an object can be precisely reproduced. In particular, by preserving points corresponding to the corner portions of an object as much as possible to accurately measure the volume of a large cargo, the outer shape of the object may be reliably represented with only a small number of points, and distortion may be prevented during mesh reconstruction. In addition, the phenomenon in which points have thickness due to noise occurring on the surface of large cargo may be alleviated, and under-estimation of the volume that may occur in mesh reconstruction may be prevented.

Unlike the conventional random extraction method, a point cloud sampling technique according to embodiments selects the representative points by reflecting the shape, density, and geometric features of the ground-truth point cloud, and accordingly, data can be made lighter without quality deterioration of mesh reconstruction. As a result, when reconstructing a mesh by sampling approximately 12,747,264 raw points, the algorithm calculation time that previously took more than 10 minutes is shortened to less than 10 seconds, and the usage of computing memory may also be significantly reduced, improving the overall computational efficiency. Furthermore, it was confirmed that the accuracy of volume calculation after mesh reconstruction is actually improved, so that precise shape restoration and volume measurement of large cargo can be realized.

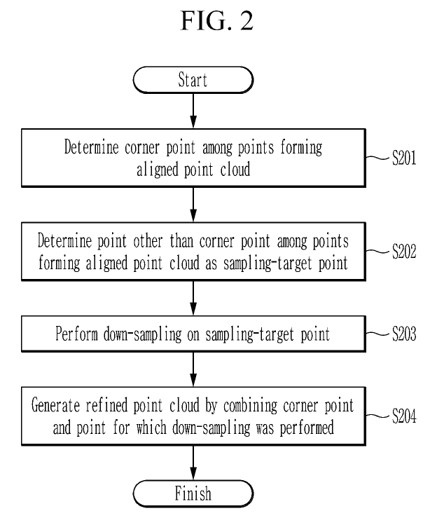

FIG. 2 illustrates a drawing for explaining a method for measuring cargo, according to an exemplary embodiment.

Referring to FIG. 2, a method for measuring cargo, according to an exemplary embodiment, may comprise a step S201 of determining the corner point among the points forming the aligned point cloud, a step S202 of determining a point other than the corner point among the points forming the aligned point cloud as the sampling-target point, a step S203 of performing down-sampling with respect to the sampling-target point, and a step S204 of generating the refined point cloud, by combining the point for which the down-sampling was performed and corner point.

For more detailed information about the above method, reference can be made to the description of the embodiments described in this specification, so a redundant description is not included herein.

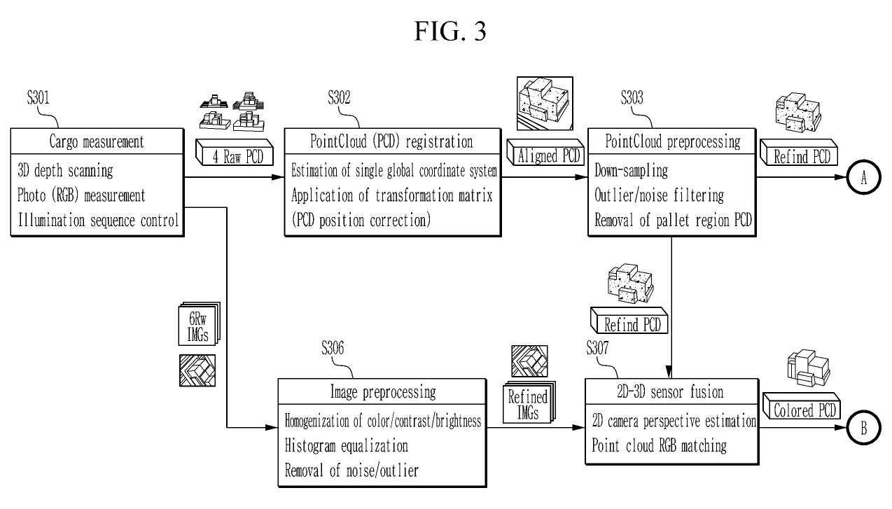

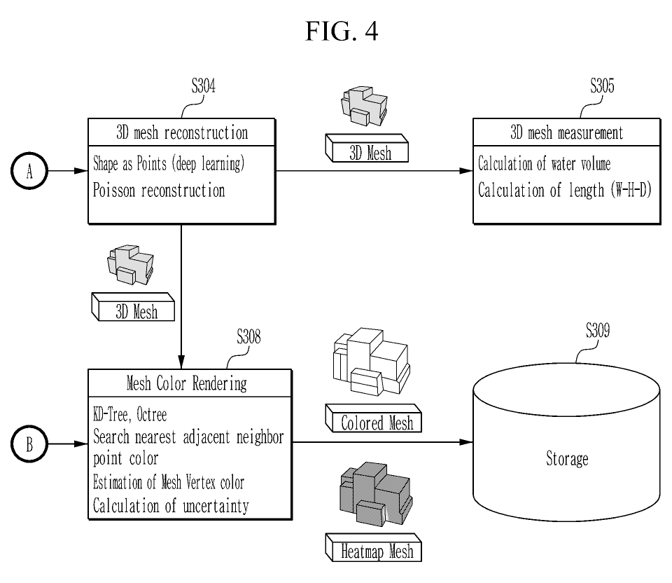

FIG. 3 and FIG. 4 illustrate drawings for explaining a method for measuring cargo, according to an exemplary embodiment.

Referring to FIGS. 3 and 4, a method for measuring cargo, according to an exemplary embodiment, may comprise performing a cargo measurement step S301. In this step, 3D depth scanning and RGB photographing are performed in order to measure a 3D shape of the cargo. By controlling the illumination sequence, the measurement environment may be optimized, and high-quality data may be collected. Four raw point clouds and six raw images may be output as results.

A step S302 may be a point cloud registration step. This step may be performed by receiving the output of the cargo measurement step S301 as input. The four raw point clouds may be aligned to a single global coordinate system, and a position of each point cloud may be corrected by applying a transformation matrix. Finally, the aligned point cloud may be generated.

A step S303 may be a point cloud preprocessing step. This step may use the results of the point cloud registration step S302 as input. The size of data may be reduced through down-sampling, and the quality of data may be improved by filtering out outliers and noise. In addition, the refined point cloud may be output by removing the point cloud of the pallet region.

A step S304 may be a 3D mesh reconstruction step. In this step, the refined point cloud of the point cloud preprocessing step S303 may be received as input, and the 3D mesh may be generated. A precise 3D mesh may be constructed by utilizing deep learning-based “Shape as Points” and Poisson reconstruction technique. The 3D mesh may be output as results.

A step S305 may be a 3D mesh measurement step. In this step, the measurement work may be performed by using the 3D mesh generated in the 3D mesh reconstruction step S304. By calculating the water volume, and measuring the height, width, and depth (W-H-D) of mesh, the volume and shape of the cargo may be accurately analyzed.

A step S306 may be an image preprocessing step. This step may use the six raw images collected in the cargo measurement step S301 as input. The image quality may be improved by homogenizing the color, contrast, and brightness, and by performing histogram equalization and noise removal. As a result, a refined image may be generated.

A step S307 may be a 2D-3D sensor fusion step. This step may be performed by using the output of the point cloud preprocessing step S303 and the image preprocessing step S306. The colored point cloud may be generated performing perspective estimation of the 2D camera, and matching the point cloud with an RGB image.

A step S308 may a mesh color rendering step. In this step, the 3D mesh generated in the 3D mesh reconstruction step S304 and the colored point cloud of the 2D-3D sensor fusion step S307 may be used as input. In this process, a color of a neighbor point nearest adjacent to each vertex of the mesh may be searched by utilizing the KD-Tree and octree, and the colors of the mesh vertices may be estimated based on this. In addition, the reliability of the mesh may be evaluated by calculating the uncertainty value with respect to the color estimation. As a result, the colored mesh and the heatmap mesh may be generated, so that 3D visualization of the cargo can be strengthened.

A step S309 may be a step of storing the generated mesh. In the last step, the colored mesh and the heatmap mesh generated in the mesh color rendering step S308 may be stored. These may be stored in a database or file system, for later analysis or reference.

In accordance with the above process flow, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

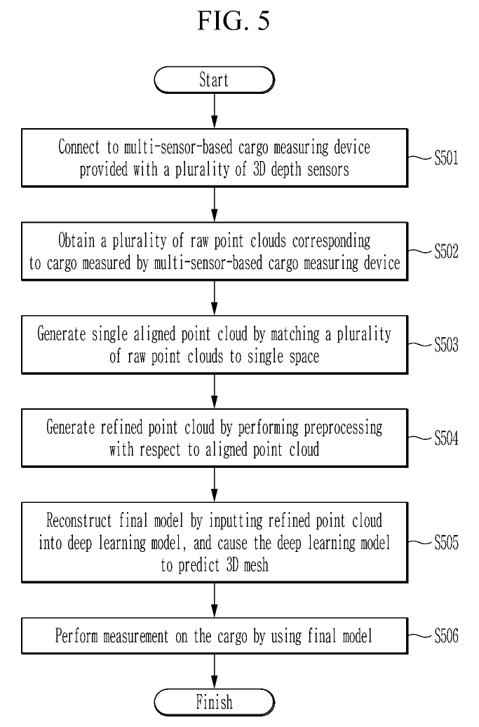

FIG. 5 illustrates a drawing for explaining a method for measuring cargo, according to an exemplary embodiment.

Referring to FIG. 5, a method for measuring cargo, according to an exemplary embodiment, may comprise a step S501 of connecting to the multi-sensor-based cargo measuring device provided with the plurality of 3D depth sensors, a step S502 of obtaining the plurality of raw point clouds corresponding to the cargo measured by the multi-sensor-based cargo measuring device, a step S503 of generating the single aligned point cloud by matching the plurality of raw point clouds to a single space, a step S504 of generating the refined point cloud by performing preprocessing on the aligned point cloud, a step S505 of reconstructing the final model by inputting the refined point cloud into a deep learning model, and causing the deep learning model to predict the 3D mesh, and a step S506 of performing measurement on the cargo by using the final model.

For more detailed information about the above method, reference can be made to the description of the embodiments described in this specification, so a redundant description is not included herein.

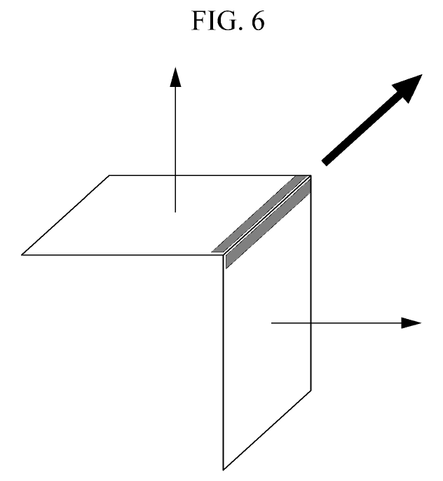

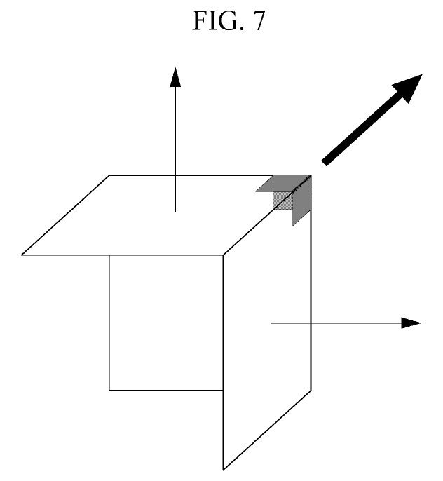

FIGS. 6 and 7 illustrate drawings for explaining implementation examples of a method and apparatus for measuring cargo, according to an exemplary embodiment.

Referring to FIGS. 6 and 7, the point cloud processing module 10 may be configured to determine the corner point among the points forming the aligned point cloud by analyzing the shape change of the aligned point cloud. Here, the corner point may mean a point corresponding to a boundary where two adjacent surfaces meet, as shown in FIG. 6, and may mean a point corresponding to a boundary where three adjacent surfaces meet as shown in FIG. 7.

The point cloud processing module 110 may be configured to estimate a normal vector with respect to each point with respect to the entire region of the aligned point cloud, determine a direction of a surface on which each point is located based on the normal vector, may determine the corner point based on the direction of the surface, may determine a curvature corresponding to each point based on the normal vector, and may determine the corner point based on the curvature. On the other hand, the point cloud processing module 110 may be configured to determine the normal vector differences between the points, with respect to the entire region of the aligned point cloud, and determine the corner point based on the normal vector differences between the points.

FIG. 8 illustrates a drawing for explaining a computing device, according to an exemplary embodiment.

Referring to FIG. 8, a method and apparatus for measuring cargo, according to an exemplary embodiment, may be implemented by using the computing device 50. The computing device 50 may comprise and/or be implemented as various forms of electronic devices, servers, or similar devices, and its function may be implemented through a combination of software and hardware.

The computing device 50 may comprise at least one of a processor 510, a memory 530, a user interface input device 540, a user interface output device 550, and a storage device 560 that communicate through a bus 520. The computing device 50 may also comprise a network interface 570 electrically connected to the network 40. The network interface 570 may be configured to transmit or receive signals with other entities through the network 40.

The processor 510 may comprise and/or be implemented as various types of computing devices, for example, a micro controller unit (MCU), an application processor (AP), a central processing unit (CPU), a graphics processing unit (GPU), a neural processing unit (NPU), quantum processing unit (QPU), or the like. The processor 510 may comprise a semiconductor device that is configured to execute instructions stored in the memory 530 or the storage device 560, and may be configured to play a core role of the system. The program code and data stored in the memory 530 or the storage device 560 may be configured to command the processor 510 to perform a specific work, thereby enabling the overall operation of the system. The processor 510 may be configured to implement various functions and methods described above with reference to FIGS. 1-7.

The memory 530 and the storage device 560 may comprise various types of volatile or non-volatile storage media for storing and accessing data of the system. For example, the memory 530 may comprise a read-only memory (ROM) 531 and a random-access memory (RAM) 532. According to an exemplary embodiment, the memory 530 may be built into the processor 510, in which case, the data transmission speed between the memory 530 and the processor 510 may be very fast. According to an exemplary embodiment, the memory 530 may be located outside the processor 510, in which case, the memory 530 may be connected to the processor 510 through various data buses or interfaces. This connection may be made through already known various means, for example, a Peripheral Component Interconnect Express (PCIe) interface for high-rate data transmission or a memory controller.

According to an exemplary embodiment, at least some of components or functions of a method and apparatus for measuring cargo according to embodiments may be implemented as a program or software executed by the computing device 50, and the program or software may be stored in computer-readable recording medium or storage medium. Specifically, a computer-readable recording medium or storage medium, according to an exemplary embodiment, may be configured to record a program for executing steps included in an implementation of the method and apparatus for measuring cargo according to embodiments, on a computer including the processor 510 executing a program or instructions stored in the memory 530 or the storage device 560.

According to an exemplary embodiment, at least some of components or functions of a method and apparatus for measuring cargo according to embodiments may be implemented by using hardware or circuitry of the computing device 50, or may implemented as separate hardware or circuitry that may be electrically connected to the computing device 50.

According to an exemplary embodiment, one or more non-transitory computer-readable media including an instruction executable by a computing device 50 may be provided, where the instruction may cause the computing device 50 to perform the operation when executed by one or more processors of the computing device 50. Here, the operation may comprise components, functions, steps, or the like, described in this specification with respect to a method and apparatus for measuring cargo according to embodiments.

According to an exemplary embodiment, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In particular, unnecessary points may be removed from the 3D point cloud obtained from the multi-sensor-based cargo measuring device, and the 3D mesh may be efficiently generated by selecting and sampling only representative points. Accordingly, the amount of data of the point cloud can be reduced, and the shape and volume of an object can be precisely reproduced. In particular, by preserving points corresponding to the corner portions of an object as much as possible to accurately measure the volume of a large cargo, the outer shape of the object may be reliably represented with only a small number of points, and distortion may be prevented during mesh reconstruction. In addition, the phenomenon in which points have thickness due to noise occurring on the surface of large cargo may be alleviated, and under-estimation of the volume that may occur in mesh reconstruction may be prevented.

Unlike the conventional random extraction method, a point cloud sampling technique according to embodiments selects the representative points by reflecting the shape, density, and geometric features of the ground-truth point cloud, and accordingly, data can be made lighter without quality deterioration of mesh reconstruction. As a result, when reconstructing a mesh by sampling approximately 12,747,264 raw points, the algorithm calculation time that previously took more than 10 minutes is shortened to less than 10 seconds, and the usage of computing memory may also be significantly reduced, improving the overall computational efficiency. Furthermore, it was confirmed that the accuracy of volume calculation after mesh reconstruction is actually improved, so that precise shape restoration and volume measurement of large cargo can be realized.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A method for measuring cargo, comprising:
using a computing device comprising a processor and a memory:
obtaining a plurality of raw point clouds corresponding to cargo measured by a multi-sensor-based cargo measuring device provided with a plurality of 3D depth sensors;
generating a single aligned point cloud by matching the plurality of raw point clouds to a single space;
determining a corner point among points forming the aligned point cloud;
determining a point other than the corner point among the points forming the aligned point cloud as a sampling-target point;
performing down-sampling on the sampling-target point;
generating a refined point cloud by combining the point for which the down-sampling was performed and corner point;
reconstructing a final model by inputting the refined point cloud into a deep learning model, and causing the deep learning model to predict a 3D mesh; and
performing a measurement with respect to the cargo by using the final model.

2. The method of claim 1, wherein the determining the corner point comprises determining the corner point among the points forming the aligned point cloud based on voxels.

3. The method of claim 2, wherein the determining the corner point comprises:
generating a plurality of voxel grids by performing voxelization on an entire region of the aligned point cloud;
identifying a portion where a shape change exceeds a predetermined threshold value by analyzing distribution of internal points, for each of the plurality of voxel grids; and
determining a point corresponding to the portion where the shape change exceeds the predetermined threshold value, as the corner point.

4. The method of claim 1, wherein the determining the corner point comprises determining the corner point among the points forming the aligned point cloud by analyzing a shape change of the aligned point cloud.

5. The method of claim 4, wherein the determining the corner point comprises:
estimating a normal vector with respect to each point, with respect to an entire region of the aligned point cloud;
determining a direction of a surface on which each point is located based on the normal vector; and
determining the corner point based on a direction of the surface.

6. The method of claim 4, wherein the determining the corner point comprises:
estimating a normal vector with respect to each point, with respect to an entire region of the aligned point cloud;
determining a curvature corresponding to each point based on the normal vector; and
determining the corner point based on the curvature.

7. The method of claim 4, wherein the determining the corner point comprises:
determining normal vector differences between the points, with respect to an entire region of the aligned point cloud; and
determining the corner point based on the normal vector differences between the points.

8. The method of claim 1, wherein the reconstructing the final model comprises:
constructing a K-dimensional tree (KD-Tree) space based on a mesh vertex of the 3D mesh;
placing a colored point cloud in the KD-Tree space; and
calculating adjacent points and distances between the adjacent points.

9. The method of claim 8, wherein the reconstructing the final model comprises:
performing color matching by collecting colors of points adjacent to the mesh vertex; and
reconstructing a colored mesh into the final model.

10. The method of claim 8, wherein the reconstructing the final model comprises:
generating a heatmap mesh based on the distance between the adjacent points; and
reconstructing the heatmap mesh into the final model.

11. An apparatus for measuring cargo, comprising:
a computing device, comprising a processor and a memory, the computing device being configured to:
obtain a plurality of raw point clouds corresponding to cargo measured by a multi-sensor-based cargo measuring device provided with a plurality of 3D depth sensors;
generate a single aligned point cloud by matching the plurality of raw point clouds to a single space;
determine a corner point among points forming the aligned point cloud;
determine a point other than the corner point among the points forming the aligned point cloud as a sampling-target point;
perform down-sampling on the sampling-target point;
generate a refined point cloud, by combining the point for which the down-sampling was performed and corner point;
reconstruct a final model by inputting the refined point cloud into a deep learning model, and causing the deep learning model to predict a 3D mesh; and
perform a measurement with respect to the cargo by using the final model.

12. The apparatus of claim 11, wherein the determining the corner point comprises determining the corner point among the points forming the aligned point cloud based on voxels.

13. The apparatus of claim 12, wherein the determining the corner point comprises:
generating a plurality of voxel grids by performing voxelization on an entire region of the aligned point cloud;
identifying a portion where a shape change exceeds a predetermined threshold value by analyzing distribution of internal points, for each of the plurality of voxel grids; and
determining a point corresponding to the portion where the shape change exceeds the predetermined threshold value, as the corner point.

14. The apparatus of claim 11, wherein the determining the corner point comprises determining the corner point among the points forming the aligned point cloud by analyzing a shape change of the aligned point cloud.

15. The apparatus of claim 14, wherein the determining the corner point comprises:
estimating a normal vector with respect to each point, with respect to an entire region of the aligned point cloud;
determining a direction of a surface on which each point is located based on the normal vector; and
determining the corner point based on a direction of the surface.

16. The apparatus of claim 14, wherein the determining the corner point comprises:
estimating a normal vector with respect to each point, with respect to an entire region of the aligned point cloud;
determining a curvature corresponding to each point based on the normal vector; and
determining the corner point based on the curvature.

17. The apparatus of claim 14, wherein the determining the corner point comprises:
determining normal vector differences between the points, with respect to an entire region of the aligned point cloud; and
determining the corner point based on the normal vector differences between the points.

18. The apparatus of claim 11, wherein the reconstructing the final model comprises:
constructing a K-dimensional tree (KD-Tree) space based on a mesh vertex of the 3D mesh;
placing a colored point cloud in the KD-Tree space; and
calculating adjacent points and distances between the adjacent points.

19. The apparatus of claim 18, wherein the reconstructing the final model comprises:
performing color matching by collecting colors of points adjacent to the mesh vertex and reconstructing a colored mesh into the final model; or
generating a heatmap mesh based on the distance between the adjacent points, and reconstructing the heatmap mesh into the final model.

20. A computing device, comprising:
a processor; and
a memory,
wherein the memory is configured to store instructions that, when executed by the processor, are configured to cause the processor to:
obtain a plurality of raw point clouds corresponding to a cargo measured by a multi-sensor-based cargo measuring device provided with a plurality of 3D depth sensors;
generate a single aligned point cloud by matching the plurality of raw point clouds to a single space;
determine a corner point among points forming the aligned point cloud;
determine a point other than the corner point among the points forming the aligned point cloud as a sampling-target point;
perform down-sampling on the sampling-target point;
generate a refined point cloud, by combining the point for which the down-sampling was performed and corner point;
reconstruct a final model by inputting the refined point cloud into a deep learning model, and causing the deep learning model to predict a 3D mesh; and
perform a measurement with respect to the cargo by using the final model.
